(19) United States
(12) Patent Application Publication
(10) Pub. No.: US 2025/0151180 A1
(43) Pub. Date: May 8, 2025

(54) COOKING DEVICE HAVING LIQUID GUIDE SLOPE

(71) Applicant: SAMSUNG ELECTRONICS CO., LTD., Suwon-si Gyeonggi-do (KR)

(72) Inventors: Sangjin JEONG, Suwon-si (KR); Sangwon YUN, Suwon-si (KR)

(73) Assignee: SAMSUNG ELECTRONICS CO., LTD., Suwon-si Gyeonggi-do (KR)

(21) Appl. No.: 19/018,239

(22) Filed: Jan. 13, 2025

Related U.S. Application Data
(63) Continuation of application No. PCT/KR2023/009965, filed on Jul. 12, 2023.

(30) Foreign Application Priority Data
Jul. 27, 2022 (KR) 10-2022-0093377
Sep. 8, 2022 (KR) 10-2022-0114351

(51) Int. Cl. H05B 6/64

(52) U.S. Cl. CPC H05B 6/6414; H05B 6/6435

(57) ABSTRACT

A cooking device includes: a main body which forms a cooking chamber, and which has, in the front surface thereof, an opening to the cooking chamber; and a door assembly to open/close the opening of the main body. The door assembly includes: a door plate having an inspection window; a joining groove arrangeable along a horizontal direction on the upper side of the inspection window on a front surface of the door plate; a door glass attachable to the front surface of the door plate; and an adhesive arrangeable in the joining groove and which couples the door plate and the door glass. A lower end of an upper portion of the door plate is located relative to an upper side of the joining groove facing the door glass, and inclined downward toward a side end of the door plate.

### CROSS-REFERENCE TO RELATED APPLICATION

This application is a continuation application, under 35 U.S.C. §111(a), of international application No. PCT/KR2023/009965, filed Jul. 12, 2023, which claims priority under 35 U.S.C. §119 to Korean Patent Application No. 10-2022-0093377, filed Jul. 27, 2022, and Korean Patent Application No. 10-2022-θ114351, filed Sep. 8, 2022, the disclosures of which are incorporated herein by reference in their entireties.

### DESCRIPTION

### Technical Field

The disclosure relates to a cooking device, and more particularly, to a cooking device having a liquid guide slope.

### Background Art

Generally, a cooking device may include a cooking chamber and a door assembly for opening and closing the cooking chamber. The door assembly may include a door plate and a door glass coupled to a front surface of the door plate.

In addition, an operation panel for controlling the cooking device may be disposed on a front surface of the cooking device. The operation panel may include a panel body and a glass panel coupled to a front surface of the panel body.

When cleaning the cooking device or spilling water on the top of the cooking device, liquid such as water or cleaning agent on the upper surface of the cooking device may penetrate the door assembly and the operation panel.

In detail, liquid such as water or cleaning agent may penetrate between the door plate and the door glass, or between the panel body and the glass panel.

### DISCLOSURE OF THE INVENTION

### Technical Solution

According to an embodiment of the disclosure, a cooking device may include: a main body configured to form a cooking chamber and including an opening to the cooking chamber at a front surface of the main body; and a door assembly to open and close the opening of the main body. The door assembly may include: a door plate with an inspection window; a joining groove arrangeable on an upper side of the inspection window on a front surface of the door plate along a horizontal direction; a door glass attachable to the front surface of the door plate; and an adhesive arrangeable in the joining groove and configured to connect the door plate and the door glass. A lower end of an upper portion of the door plate is located relative to an upper side of the joining groove facing the door glass, and may be formed to be inclined downward toward a side end of the door plate.

The lower end of the upper portion of the door plate may be formed to slope downward from a center toward both side ends of the lower end.

The door plate may further include an additional joining groove arrangeable between the joining groove and the inspection window. A lower end of a middle portion of the door plate, which is located between the joining groove and the additional joining groove facing the door glass, may be formed to slope downward toward the side end of the door plate.

The lower end of the middle portion of the door plate may be formed to be more inclined downward than the lower end of the upper portion of the door plate.

The lower end of the middle portion of the door plate may be formed to be inclined downward from a center toward both side ends of the lower end.

The door plate may further include a pair of discharge grooves formed vertically on both sides of the inspection window.

The main body may further includes a panel section arrangeable on the front surface on one side of the opening; and an operation panel to be disposed on the panel section.

The operation panel may include: a panel body disposed on the panel section; a keypad on a front surface of the panel body; a panel joining groove arrangeable on an upper side of the keypad on the front surface of the panel body in a horizontal direction; a glass panel disposed on the front surface of the panel body to cover the keypad; and an adhesive arrangeable in the panel joining groove and configured to connect the panel body and the glass panel. A lower end of an upper portion of the panel body, which is located on an upper side of the panel joining groove and faces the glass panel, may be formed to be inclined downward toward a side end of the panel body.

The panel body may further include an additional panel joining groove provided between the panel joining groove and the keypad. A lower end of a middle portion of the panel body, which is located between the panel joining groove and the additional panel joining groove and faces the glass panel, may be formed to slope downward toward the side end of the panel body.

The lower end of the middle portion of the panel body may be formed to be more inclined downward than the lower end of the upper portion of the panel body.

The lower end of the upper portion of the panel body and the lower end of the middle portion of the panel body may be formed to be inclined downward from a center of the lower end toward both side ends of the lower end.

The panel body may further include a pair of discharge grooves formed vertically on both sides of the keypad.

A cooking device according to an embodiment of the disclosure may include: a main body; and an operation panel on a front surface of the main body. The operation panel may include: a panel body disposed on the front surface of the main body; a keypad on a front surface of the panel body; a panel joining groove provided on an upper side of the keypad on the front surface of the panel body in a horizontal direction; a glass panel disposed on the front surface of the panel body to cover the keypad; and an adhesive provided in the panel joining groove and configured to connect the panel body and the glass panel. A lower end of an upper portion of the panel body, which is located on an upper side of the panel joining groove and faces the glass panel, may be formed to be inclined downward toward a side end of the panel body.

### BRIEF DESCRIPTION OF DRAWINGS

These and/or other aspects, features, and advantages of certain embodiments of the disclosure will be more apparent from the following description taken in conjunction with the accompanying drawings, in which:

FIG. 1 is a perspective view illustrating a cooking device according to an embodiment of the disclosure.

FIG. 2 is an exploded perspective view illustrating a door assembly of the cooking device of FIG. 1 according to an embodiment of the disclosure.

FIG. 3 is a cross-sectional view illustrating a door assembly of the cooking device of FIG. 1 taken along a line I-I according to an embodiment of the disclosure.

FIG. 4 is a perspective view illustrating a door plate of the door assembly of FIG. 2 according to an embodiment of the disclosure.

FIG. 5 is a plan view illustrating a door plate according to an embodiment of the disclosure.

FIG. 6 is a partial enlarged view illustrating a part A of FIG. 5 according to an embodiment of the disclosure.

FIG. 7 is a partial enlarged view illustrating a part B of FIG. 6 according to an embodiment of the disclosure.

FIG. 8 is a plan view illustrating a door plate according to an embodiment of the disclosure.

FIG. 9 is a partial enlarged view illustrating a part C of FIG. 8 according to an embodiment of the disclosure.

FIG. 10 is a partial cross-sectional view illustrating a state in which liquid penetrates into a door assembly of a cooking device according to an embodiment of the disclosure.

FIG. 11 is a view illustrating a flow of liquid that has penetrated into a door assembly of a cooking device according to the prior art.

FIG. 12 is a view illustrating a flow of liquid that has penetrated into a door assembly of a cooking device according to an embodiment of the disclosure.

FIG. 13 is an exploded perspective view illustrating an operation panel of the cooking device of FIG. 1 according to an embodiment of the disclosure.

FIG. 14 is a perspective view illustrating a panel body of the operation panel of FIG. 13 according to an embodiment of the disclosure.

FIG. 15 is a cross-sectional view illustrating an operation panel of the cooking device of FIG. 1 taken along a line II-II according to an embodiment of the disclosure.

FIG. 16 is a plan view illustrating a panel body according to an embodiment of the disclosure.

FIG. 17 is a partial enlarged view illustrating a part D of FIG. 16 according to an embodiment of the disclosure.

FIG. 18 is a plan view illustrating a panel body according to an embodiment of the disclosure.

FIG. 19 is a partial cross-sectional view illustrating a state in which liquid penetrates into an operation panel of a cooking device according to an embodiment of the disclosure.

FIG. 20 is a view illustrating a flow of liquid that has penetrated into an operation panel of a cooking device according to the prior art.

FIG. 21 is a view illustrating a flow of liquid that has penetrated into an operation panel of a cooking device according to an embodiment of the disclosure.

### BEST MODE FOR CARRYING OUT THE INVENTION

Since the embodiments of the disclosure can apply various transformations and have various embodiments, specific embodiments will be illustrated in the drawings and described in detail in the detailed description. However, this is not intended to limit the scope to the specific embodiments, and should be understood to include various modifications, equivalents, and/or alternatives of the embodiment of the disclosure. In connection with the description of the drawings, like reference numerals may be used for like elements.

In describing the disclosure, when it is determined that a detailed description of a related known function or configuration may unnecessarily obscure the gist of the disclosure, a detailed description thereof will be omitted.

In addition, the following embodiments may be modified in many different forms, and the scope of the technical idea of the disclosure is not limited to the following embodiments. Rather, these embodiments are provided so that this disclosure will be thorough and complete, and will fully convey the spirit of the disclosure to those skilled in the art.

Terms used in this disclosure are only used to describe specific embodiments, and are not intended to limit the scope of rights. Singular expressions include plural expressions unless the context clearly dictates otherwise.

In this disclosure, expressions such as “has,” “can have”, “includes,” or “can include” indicate the existence of a corresponding feature (e.g., numerical value, function, operation, or component such as a part) and do not preclude the existence of additional features.

In this disclosure, expressions such as “A or B,” “at least one of A or/and B,” or “one or more of A or/and B” may include all possible combinations of the items listed together. For example, “A or B,” “at least one of A or/and B,” or “one or more of A or/and B” may refer to all cases (1) including at least one A, (2) including at least one B, or (3) including both at least one A and at least one B.

Expressions such as “first,” “second,” “primary,” or “secondary,” as used in this disclosure may modify various components regardless of order and/or importance, are used only to distinguish one component from other components, and do not limit the corresponding components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, a cooking device 1 according to embodiments of the disclosure will be described in detail with reference to the attached drawings.

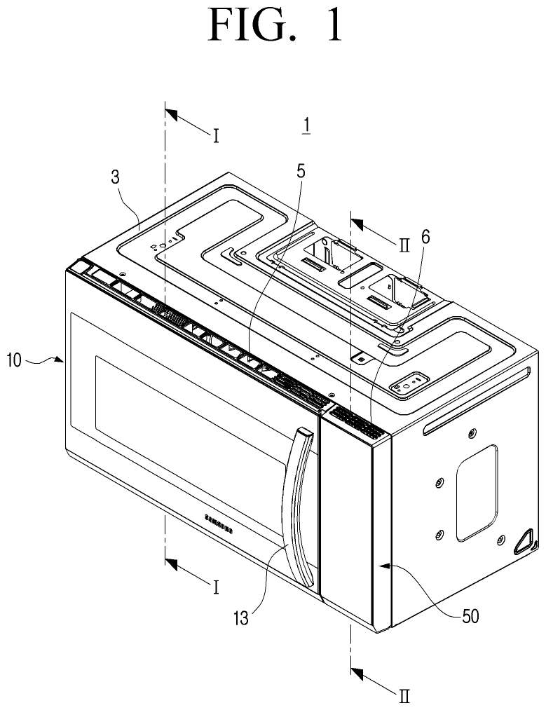

FIG. 1 is a perspective view illustrating a cooking device 1 according to an embodiment of the disclosure.

Referring to FIG. 1, a cooking device 1 may include a main body 3 and a door assembly 10.

The main body 3 may form a cooking chamber. In other words, a space that may be used as the cooking chamber may be provided inside the main body 3, and an opening communicating with the cooking chamber may be provided on a front surface 5 of the main body 3.

For example, the main body 3 may be formed in an approximately rectangular parallelepiped shape, and a space forming the cooking chamber may be provided inside the main body 3. An opening communicating with the inner space may be provided on the front surface 5 of the main body 3.

The main body 3 may include the door assembly 10 configured to open and close the opening. The door assembly 10 may be hinge-connected to the front surface 5 of the main body 3. For example, one side end of the door assembly 10 may be hinge-connected to a side end of the opening provided in the front surface 5 of the main body 3. Then, the door assembly 10 may open and close the opening of the main body 3.

The door assembly 10 may include a handle 13. Accordingly, the user may open and close the door assembly 10 by holding the handle 13.

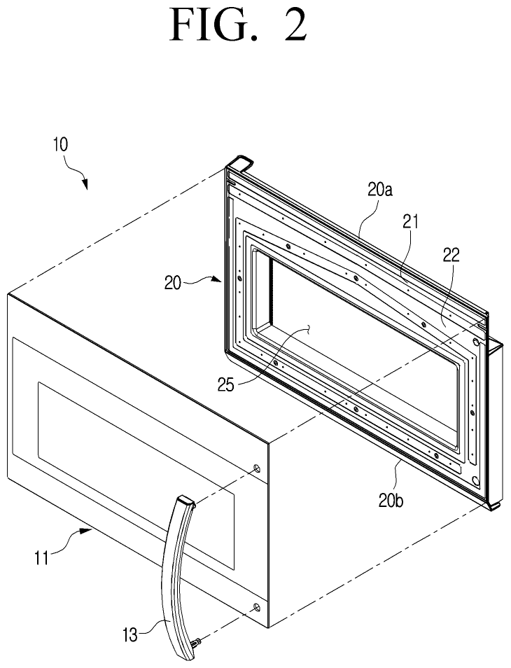

Hereinafter, the door assembly 10 will be described in detail with reference to FIGS. 2 to 7.

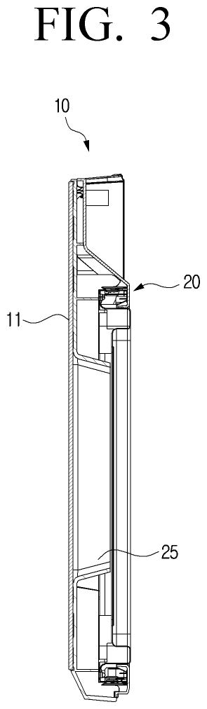

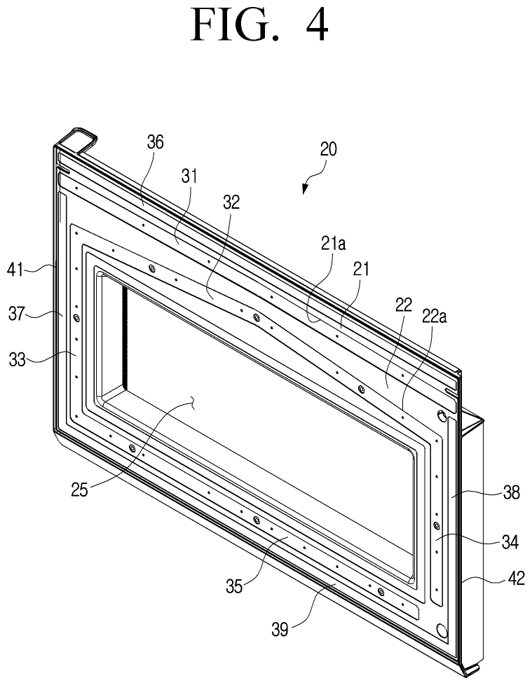

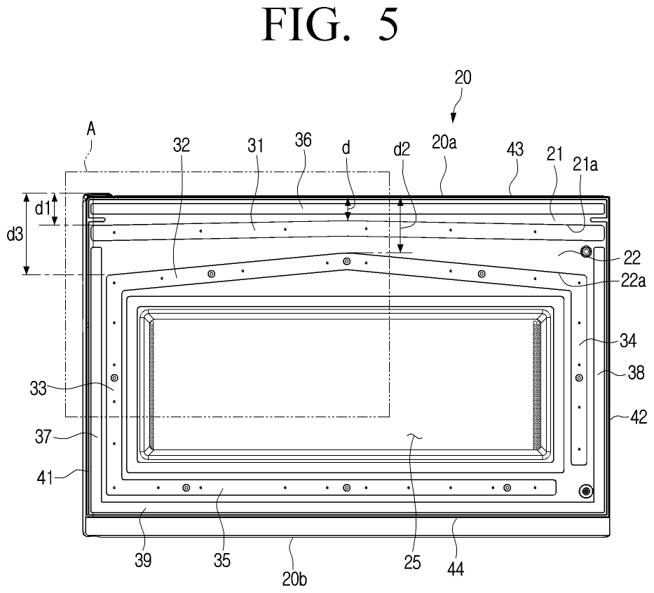

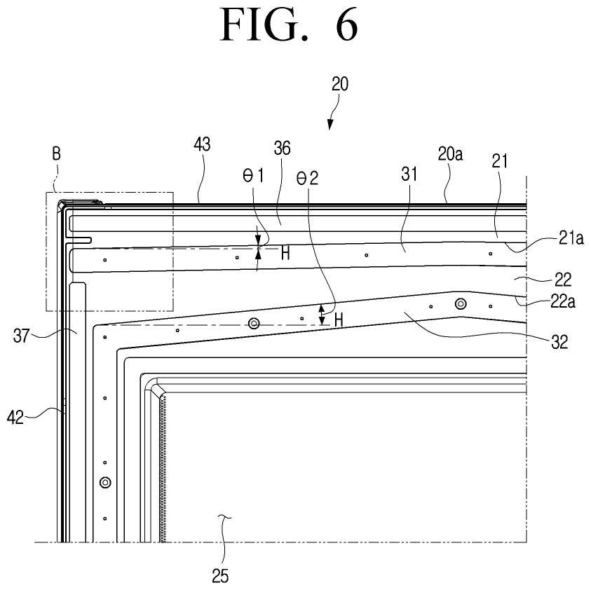

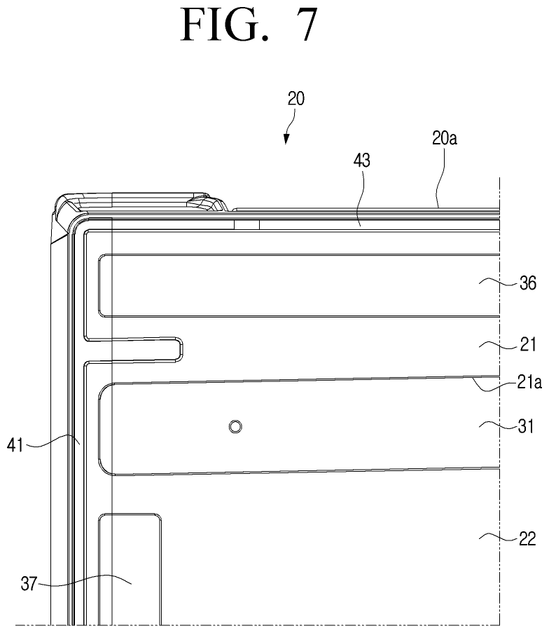

FIG. 2 is an exploded perspective view illustrating a door assembly 10 of the cooking device 1 of FIG. 1. FIG. 3 is a cross-sectional view illustrating a door assembly 10 of the cooking device 1 of FIG. 1 taken along a line I-I. FIG. 4 is a perspective view illustrating a door plate 20 of the door assembly 10 of FIG. 2. FIG. 5 is a plan view illustrating a door plate 20 according to an embodiment of the disclosure. FIG. 6 is a partial enlarged view illustrating a part A of FIG. 5. FIG. 7 is a partial enlarged view illustrating a part B of FIG. 6.

Referring to FIGS. 2 and 3, the door assembly 10 may include a door plate 20 and a door glass 11. The door plate 20 and the door glass 11 may be laminated to form the door assembly 10. For example, the door glass 11 may be attached to a front surface of the door plate 20 to form the door assembly 10. The door glass 11 may be attached to the front surface of the door plate 20 with adhesive 8 and 9.

Referring to FIGS. 4 and 5, the door plate 20 may be formed as a flat plate having an approximately rectangular shape. The door plate 20 may include an inspection window 25. The inspection window 25 may be formed as an opening penetrating the door plate 20 so as to allow viewing of the state of the cooking chamber.

For example, the inspection window 25 may be formed as a rectangular opening. However, the shape of the inspection window 25 is not limited to a rectangular shape. The inspection window 25 may be formed in various shapes such as a circle, an oval, and the like.

There may be nothing but air between the front surface of the door plate 20 and the door glass 11. In other words, there may be a narrow gap between the front surface of the door plate 20 and the door glass 11. In addition, the front surface of the door plate 20 and the door glass 11 may partially contact each other. Here, the front surface of the door plate 20 refers to the surface facing the door glass 11.

The door plate 20 may include a joining groove 31. The joining groove 31 may be formed on the front surface of the door plate 20 above the inspection window 25.

The joining groove 31 may be formed to have a defined depth on the front surface of the door plate 20. The depth of the joining groove 31 may be formed to be greater than the gap between the front surface of the door plate 20 and the door glass 11. Therefore, a capillary action may not occur between the door glass 11 and the joining groove 31.

The joining groove 31 may be provided on the door plate 20 in a horizontal direction above the inspection window 25. The bottom of the joining groove 31 may be formed lower than the front surface of the door plate 20. In other words, the front surface of the door plate 20 and the bottom of the joining groove 31 may form a step.

A portion of the door plate 20 located on the upper side of the joining groove 31, that is, a portion of the door plate 20 from the upper end of the door plate 20 to the joining groove 31, may be referred to as an upper portion 21 of the door plate 20. A lower end 21a of the upper portion 21 of the door plate 20 being in contact with the joining groove 31 may be formed to be inclined toward the side end of the door plate 20. An upper wall of the joining groove 31 may be formed to be inclined toward the side end of the door plate 20.

In other words, the lower end 21a of the upper portion 21 of the door plate 20 which is located on the upper side of the joining groove 31 and faces the door glass 11 may be formed to be inclined toward the side end of the door plate 20. An inclination angle of the lower end 21a of the upper portion 21 of the door plate 20 may be defined so that liquid penetrating between the door glass 11 and the door plate 20 flows along the lower end 21a of the upper portion 21 of the door plate 20. Here, the inclination angle θ1 of the lower end 21a of the upper portion 21 of the door plate 20 refers to an angle between the lower end 21a of the upper portion 21 of the door plate 20 and a horizontal line H. The horizontal line H refers to a straight line that passes through one end of the lower end 21a of the upper portion 21 of the door plate 20 and is parallel to the upper end 20a of the door plate 20.

When the lower end 21a of the upper portion 21 of the door plate 20 is formed to be inclined, liquid that has penetrated between the door glass 11 and the door plate 20 may flow toward the side end of the door plate 20 along the lower end 21a of the upper portion 21 of the door plate 20. In other words, the lower end 21a of the upper portion 21 of the door plate 20 may form a liquid guide slope that guides the liquid.

As illustrated in FIG. 5, the lower end 21a of the upper portion 21 of the door plate 20 may be formed to slope downward from the center of the lower end 21a to both side ends thereof. In other words, the distance d from the upper end of the door plate 20 to the center of the lower end 21a of the upper portion 21 of the door plate 20 may be shorter than the distance d1 from the upper end of the door plate 20 to both side ends of the lower end 21a of the upper portion 21 of the door plate 20.

A lower wall of the joining groove 31 may be formed parallel to the upper wall thereof. As another example, the lower wall of the joining groove 31 may be formed parallel to the upper end 20a of the door plate 20.

The joining groove 31 may accommodate adhesive 8 and 9. The adhesive 8 and 9 may be configured to join the door plate 20 and the door glass 11. For example, a double-sided tape 8 or silicone 9 may be used as the adhesive 8 and 9.

The double-sided tape 8 may be attached to the bottom of the joining groove 31. The upper surface of the double-sided tape 8 may be formed to protrude above the joining groove 31. The upper surface of the double-sided tape 8 may protrude above the front surface of the door plate 20. In other words, the thickness of the double-sided tape 8 may be greater than the depth of the joining groove 31. For example, the double-sided tape 8 may have a thickness that protrudes about 0.1 mm from the front surface of the door plate 20.

The door glass 11 may be formed in a shape and size corresponding to the door plate 20. For example, the door glass 11 may be formed in a rectangular shape having a size corresponding to the door plate 20.

When the door glass 11 is attached to the front surface of the door plate 20, a gap may be formed between the door glass 11 and the door plate 20 by the double-sided tape 8. The gap between the door glass 11 and the door plate 20 may be defined by the height of the double-sided tape 8 protruding from the front surface of the door plate 20. For example, when the double-sided tape 8 protrudes 0.1 mm from the front surface of the door plate 20, the gap between the door glass 11 and the door plate 20 may be approximately 0.1 mm.

Referring to FIGS. 4 and 5, the door plate 20 may include an additional joining groove 32. The additional joining groove 32 may be formed on the front surface of the door plate 20 in the horizontal direction.

The additional joining groove 32 may be formed below the joining groove 31. The additional joining groove 32 may be provided on the upper side of the inspection window 25. In other words, the additional joining groove 32 may be provided between the joining groove 31 and the inspection window 25 in the horizontal direction.

The additional joining groove 32 may be formed identically or similarly to the joining groove 31. For example, the additional joining groove 32 may be formed at a defined depth in the door plate 20. The bottom of the additional joining groove 32 may be formed lower than the front surface of the door plate 20. In other words, the front surface of the door plate 20 and the bottom of the additional joining groove 32 may form a step.

A portion of the door plate 20 located on the upper side of the additional joining groove 32, that is, the portion of the door plate 20 from the joining groove 31 to the additional joining groove 32, may be referred to as a middle portion 22 of the door plate 20. A lower end 22a of the middle portion 22 of the door plate 20 being in contact with the additional joining groove 32 may be formed to be inclined toward the side end of the door plate 20. An upper wall of the additional joining groove 32 may be formed to be inclined toward the side end of the door plate 20.

In other words, the lower end 22a of the middle portion 22 of the door plate 20 located on the upper side of the additional joining groove 32 and facing the door glass 11 may be formed to be inclined toward the side end of the door plate 20. When the lower end 22a of the middle portion 22 of the door plate 20 is formed to be inclined, liquid that has penetrated between the door glass 11 and the door plate 20 may flow toward the side end of the door plate 20 along the lower end 22a of the middle portion 22 of the door plate 20. That is, the lower end 22a of the middle portion 22 of the door plate 20 may form a liquid guide slope.

As illustrated in FIG. 5, the lower end 22a of the middle portion 22 of the door plate 20 may be formed to slope downward from the center of the lower end 22a to both side ends thereof. In other words, the distance d2 from the upper end 20a of the door plate 20 to the center of the lower end 22a of the middle portion 22 of the door plate 20 may be shorter than the distance d3 from the upper end 20a of the door plate 20 to both side ends of the lower end 22a of the middle portion 22 of the door plate 20.

Referring to FIG. 6, the lower end 22a of the middle portion 22 of the door plate 20 may be formed to be more inclined than the lower end 21a of the upper portion 21 of the door plate 20. In other words, the inclination angle θ2 of the lower end 22a of the middle portion 22 of the door plate 20 may be greater than the inclination angle θ1 of the lower end 21a of the upper portion 21 of the door plate 20.

A lower wall of the additional joining groove 32 may be formed parallel to the upper wall thereof. As another example, the lower wall of the additional joining groove 32 may be formed parallel to the upper end 20a of the door plate 20.

Vertical joining grooves 33 and 34 may be provided on both side ends of the additional joining groove 32. The vertical joining grooves 33 and 34 may be provided on both sides of the inspection window 25. A left vertical joining groove 33 may be provided on the left side of the inspection window 25, and a right vertical joining groove 34 may be provided on the right side of the inspection window 25. The left vertical joining groove 33 and the right vertical joining groove 34 may be connected to the additional joining groove 32.

A lower joining groove 35 may be provided below the inspection window 25. The lower joining groove 35 may be provided parallel to the lower end 20b of the door plate 20. One end the lower joining groove 35 may be connected to the vertical joining groove 33.

The additional joining groove 32, the vertical joining grooves 33 and 34, and the lower joining groove 35 may accommodate adhesive 8 and 9. The adhesive 8 and 9 may be configured to join the door plate 20 and the door glass 11. For example, double-sided tape 8 or silicone 9 may be used as the adhesive 8 and 9.

Referring again to FIG. 5, a tape groove may be provided on the edge of the front surface of the door plate 20.

The tape groove may be formed adjacent to the upper end 20a, lower end 20b, left end, and right end of the door plate 20. The tape groove may be formed in a straight line.

An upper tape groove 36 may be formed on the upper side of the joining groove 31. In other words, the upper tape groove 36 may be provided between the joining groove 31 and the upper end 20a of the door plate 20.

An upper wall of the upper tape groove 36 may be formed to be inclined toward the side end of the door plate 20 like the joining groove 31, but may be formed in a straight line to improve the joining state of the upper portion of the door plate 20 and the door glass 11.

A lower tape groove 39 may be formed below the inspection window 25. In other words, the lower tape groove 39 may be provided between the lower joining groove 35 and the lower end 20b of the door plate 20.

A left tape groove 37 may be formed on the left side of the inspection window 25. In other words, the left tape groove 37 may be provided between the left vertical joining groove 33 and the left end of the door plate 20.

A right tape groove 38 may be formed on the right side of the inspection window 25. In other words, the right tape groove 38 may be provided between the right vertical joining groove 34 and the right end of the door plate 20.

The left tape groove 37 and the right tape groove 38 may be located below the joining groove 31. In other words, the left end of the joining groove 31 may be located above the left tape groove 37, and the right end of the joining groove 31 may be located above the right tape groove 38.

The door plate 20 may include a pair of discharge grooves 41 and 42. The pair of discharge grooves 41 and 42 may be formed so that liquid that has moved to one side of the door plate 20 along the joining groove 31 flows downward. The pair of discharge grooves 41 and 42 may be formed vertically on both sides of the inspection window 25.

The pair of discharge grooves 41 and 42 may be provided adjacent to the left and right ends of the door plate 20 on both sides of the inspection window 25. A left discharge groove 41 may be provided between the left end of the door plate 20 and the left tape groove 37. A right discharge groove 42 may be provided between the right end of the door plate 20 and the right tape groove 38.

The door plate 20 may include an upper discharge groove 43 provided adjacent to the upper end 20a of the door plate 20. The upper discharge groove 43 may be provided between the upper tape groove 36 and the upper end 20a of the door plate 20.

The door plate 20 may include a lower discharge groove 44 provided adjacent to the lower end 20b of the door plate 20. The lower discharge groove 44 may be provided between the lower tape groove 39 and the lower end 20b of the door plate 20.

The upper discharge groove 43 and the lower discharge groove 44 may be formed to be connected to the left discharge groove 41 and the right discharge groove 42.

In the above, the case where the lower end 21a of the upper portion 21 of the door plate 20 and the lower end 22a of the middle portion 22 thereof are formed to be inclined from the center toward both side ends has been described, but the disclosure is not limited thereto. The inclination of the lower end 21a of the upper portion 21 of the door plate 20 and the inclination of the lower end 22a of the middle portion 22 thereof may be formed differently.

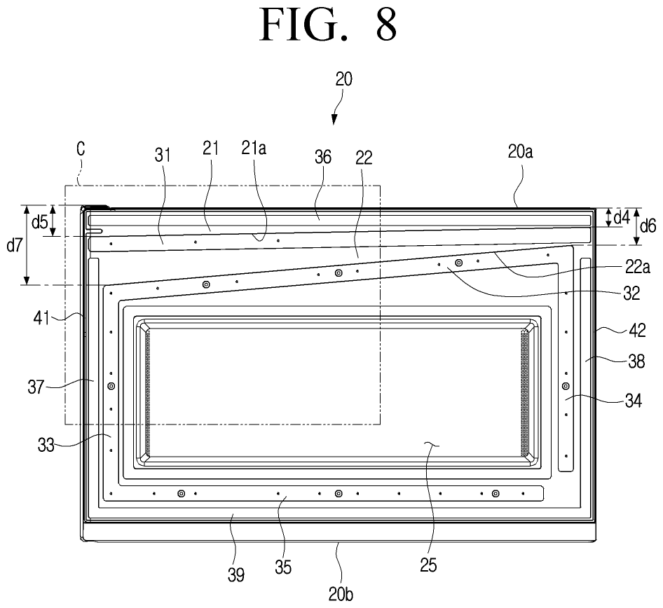

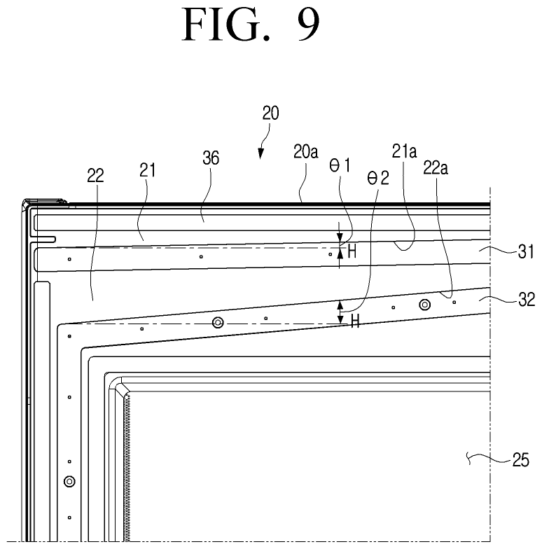

Another example of the inclinations of the lower end 21a of the upper portion 21 of the door plate 20 and the lower end 22a of the middle portion 22 thereof will be described with reference to FIGS. 8 and 9.

FIG. 8 is a plan view illustrating a door plate 20 according to an embodiment of the disclosure. FIG. 9 is a partial enlarged view illustrating a part C of FIG. 8.

Referring to FIGS. 8 and 9, the door plate 20 may be formed as a flat plate having a substantially rectangular shape. The door plate 20 may include an inspection window 25. The inspection window 25 may be formed as an opening penetrating the door plate 20 so as to allow viewing of the state of the cooking chamber.

The door plate 20 may include a joining groove 31. The joining groove 31 may be formed on the front surface of the door plate 20 above the inspection window 25.

The joining groove 31 may be formed at a defined depth on the front surface of the door plate 20. The joining groove 31 may be provided on the door plate 20 in a horizontal direction above the inspection window 25. The bottom of the joining groove 31 may be formed lower than the front surface of the door plate 20. In other words, the front surface of the door plate 20 and the bottom of the joining groove 31 may form a step.

A lower end 21a of an upper portion 21 of the door plate 20 being in contact with the joining groove 31 may be formed to be inclined toward the side end of the door plate 20. An upper wall of the joining groove 31 may be formed to be inclined toward the side end of the door plate 20.

In other words, the lower end 21a of the upper portion 21 of the door plate 20 which is located on the upper side of the joining groove 31 and faces the door glass 11 may be formed to be inclined toward the side end of the door plate 20.

As illustrated in FIG. 8, the lower end 21a of the upper portion 21 of the door plate 20 may be formed to slope downward from one side end of the door plate 20 toward the other side end thereof. In other words, the distance d4 from the upper end 20a of the door plate 20 to one end of the lower end 21a of the upper portion 21 of the door plate 20 may be shorter than the distance d5 from the upper end 20a of the door plate 20 to the other end of the lower end 21a of the upper portion 21 of the door plate 20.

For example, the lower end 21a of the upper portion 21 of the door plate 20 may be formed slope downward from the right side to the left side. In other words, the distance d4 from the upper end 20a of the door plate 20 to the right end of the lower end 21a of the upper portion 21 of the door plate 20 may be shorter than the distance d5 from the upper end 20a of the door plate 20 to the left end of the lower end 21a of the upper portion 21 of the door plate 20.

A lower wall of the joining groove 31 may be formed parallel to the upper wall thereof. As another example, the lower wall of the joining groove 31 may be formed parallel to the upper end 20a of the door plate 20.

The door plate 20 may include an additional joining groove 32 formed below the joining groove 31. The additional joining groove 32 may be formed on the front surface of the door plate 20 in the horizontal direction.

The additional joining groove 32 may be provided on the upper side of the inspection window 25. In other words, the additional joining groove 32 may be provided between the joining groove 31 and the inspection window 25 in the horizontal direction.

The additional joining groove 32 may be formed identically or similarly to the joining groove 31. For example, the additional joining groove 32 may be formed to have a defined depth on the front surface of the door plate 20. The bottom of the additional joining groove 32 may be formed lower than the front surface of the door plate 20. In other words, the front surface of the door plate 20 and the bottom of the additional joining groove 32 may form a step.

A lower end 22a of a middle portion 22 of the door plate 20, that is, a portion of the door plate 20 from the joining groove 31 to the additional joining groove 32, may be formed to be inclined toward the side end of the door plate 20. An upper wall of the additional joining groove 32 may be formed to be inclined toward the side end of the door plate 20.

In other words, the lower end 22a of the middle portion 22 of the door plate 20 located on the upper side of the additional joining groove 32 and facing the door glass 11 may be formed to be inclined toward the side end of the door plate 20.

As illustrated in FIG. 8, the lower end 22a of the middle portion 22 of the door plate 20 may be formed to slope downward from one side end of the door plate 20 to the other side end thereof. In other words, the distance d6 from the upper end 20a of the door plate 20 to one end of the lower end 22a of the middle portion 22 of the door plate 20 may be shorter than the distance d7 from the upper end 20a of the door plate 20 to the other end of the lower end 22a of the middle portion 22 of the door plate 20.

For example, the lower end 22a of the middle portion 22 of the door plate 20 may be formed slope downward from the right side to the left side. In other words, the distance d6 from the upper end 20a of the door plate 20 to the right end of the lower end 22a of the middle portion 22 of the door plate 20 may be shorter than the distance d7 from the upper end 20a of the door plate 20 to the left end of the lower end 22a of the middle portion 22 of the door plate 20.

Referring to FIG. 9, the lower end 22a of the middle portion 22 of the door plate 20 may be formed to be more inclined than the lower end 21a of the upper portion 21 of the door plate 20. In other words, the inclination angle θ2 of the lower end 22a of the middle portion 22 of the door plate 20 may be greater than the inclination angle θ1 of the lower end 21a of the upper portion 21 of the door plate 20.

A lower wall of the additional joining groove 32 may be formed parallel to the upper wall thereof. As another example, the lower wall of the additional joining groove 32 may be formed parallel to the upper end 20a of the door plate 20.

Vertical joining grooves 33 and 34 may be provided on both side ends of the additional joining groove 32, and a lower joining groove 35 may be provided below the inspection window 25. The vertical joining grooves 33 and 34 and the lower joining groove 35 are the same as or similar to them of the above-described embodiment; therefore, repeated descriptions thereof are omitted.

Hereinafter, a detailed description will be given of a flow of liquid that has penetrated the door assembly 10 of the cooking device 1 according to an embodiment of the disclosure.

When a user washes the cooking device 1 or pours water on the upper side of the cooking device 1, cleaning liquid or water may penetrate into the upper end of the door assembly 10. Hereinafter, water or cleaning liquid that may penetrate into the door assembly 10 of the cooking device 1 is referred to as liquid.

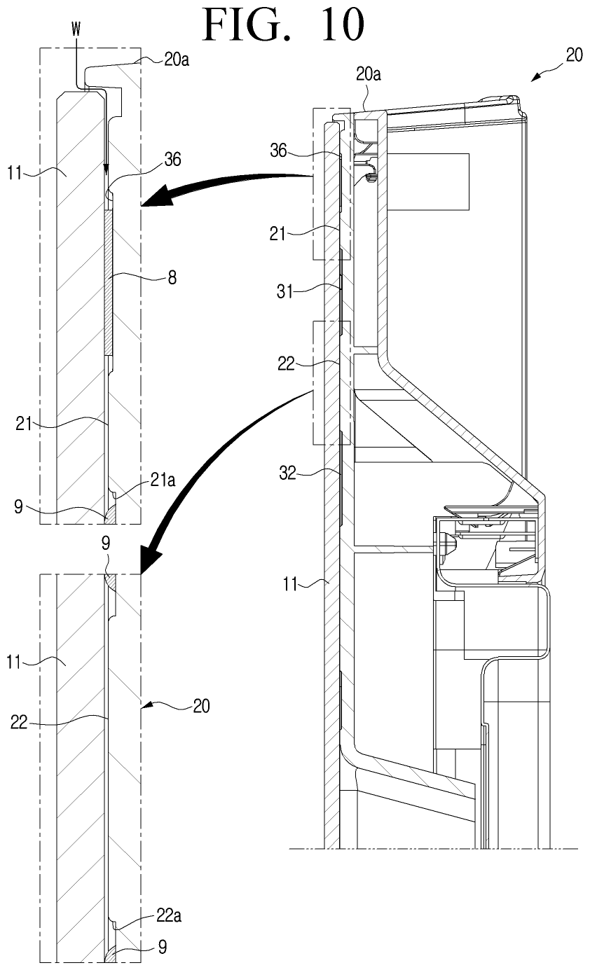

FIG. 10 is a partial cross-sectional view illustrating a state in which liquid penetrates into a door assembly 10 of a cooking device 1 according to an embodiment of the disclosure.

Referring to FIG. 10, liquid may penetrate into the upper end of the door assembly 10, that is, between the upper end of the door plate 20 and the upper end of the door glass 11.

Because a gap between the door plate 20 and the door glass 11 is very narrow, the liquid quickly spreads through the gap between the door plate 20 and the door glass 11 by capillary action.

When the liquid flowing downward through the gap between the door plate 20 and the door glass 11 meets the tape groove 36, the liquid does not flow down immediately but stays for a while. In other words, when the liquid meets the tape groove 36 which has a wider gap than the gap between the door plate 20 and the door glass 11, the liquid does not flow down immediately but stays for a while in the gap between the door plate 20 and the door glass 11 due to the surface tension of the liquid.

As time passes, the liquid flows down and collects on the double-sided tape 8 disposed in the tape groove 36. The liquid may not pass through the double-sided tape 8 directly and may be absorbed by the double-sided tape 8.

After a certain amount of time, the liquid may flow down through the double-sided tape 8.

The liquid passing through the double-sided tape 8 may penetrate into the gap between the door plate 20 and the door glass 11.

Because the gap between the door plate 20 and the door glass 11 is very narrow, the liquid quickly spreads through the gap between the door plate 20 and the door glass 11 by capillary action.

When the liquid flowing downward through the gap between the door plate 20 and the door glass 11 meets the joining groove 31, the liquid does not flow down immediately but stays for a while.

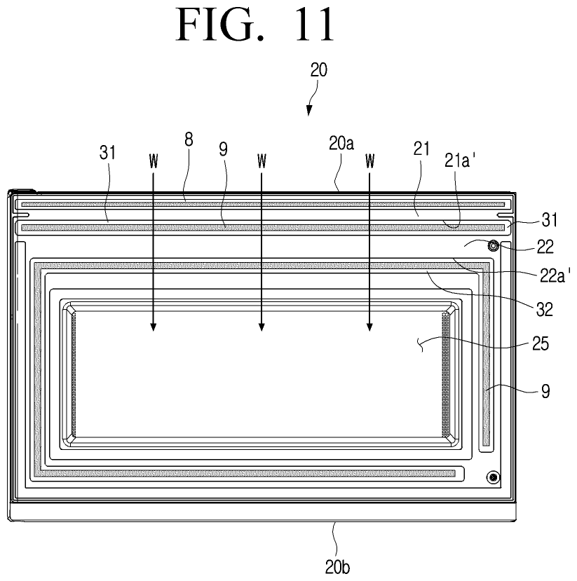

When the lower end 21a of the upper portion 21 of the door plate 20 on the upper side of the joining groove 31 is formed horizontally, the liquid flows down directly into the joining groove 31 as illustrated in FIG. 11.

FIG. 11 is a view illustrating a flow of liquid that has penetrated into a door assembly of a cooking device according to the prior art.

Referring to FIG. 11, the lower end 21a′ of the upper portion 21 of the door plate 20 is formed horizontally parallel to the lower end 20b of the door plate 20. In this case, the liquid passing through the gap between the upper portion 21 of the door plate 20 and the door glass 11 flows down to the joining groove 31, and then flows downward through the silicone 9 provided in the joining groove 31.

Because the entire upper surface of the silicone 9 provided in the joining groove 31 is not completely in contact with the door glass 11, the liquid may flow downward through the gap between the door glass 11 and the silicone 9.

The liquid that has passed through the joining groove 31 quickly spreads through the gap between the middle portion 22 of the door plate 20 and the door glass 11 by capillary action, and passes through the gap between the middle portion 22 of the door plate 20 and the door glass 11.

The lower end 22a′ of the middle portion 22 of the door plate 20 is formed horizontally parallel to the lower end 20b of the door plate 20. Therefore, the liquid passing through the gap between the middle portion 22 of the door plate 20 and the door glass 11 flows down into the additional joining groove 32, and then flows downward through the silicone 9 provided in the additional joining groove 32.

Because the entire upper surface of the silicone 9 provided in the additional joining groove 32 is not completely in contact with the door glass 11, the liquid may flow downward through the gap between the door glass 11 and the silicone 9.

The liquid passing through the additional joining groove 32 flows down along a portion of the door glass 11 covering the inspection window 25. Then, the liquid may form droplets on the inner surface of the door glass 11 corresponding to the inspection window 25. Or, after the liquid evaporates, traces of the liquid may remain on the inner surface of the door glass 11. When the traces of the liquid remain on the inner surface of the door glass 11 corresponding to the inspection window 25, the user may feel uncomfortable when viewing the inside of the cooking chamber through the inspection window 25.

However, when the lower end 21a of the upper portion 21 of the door plate 20 and the lower end 22a of the middle portion 22 of the door plate 20 are formed to be inclined as in the disclosure, it is possible to prevent liquid traces from remaining on the inner surface of the door glass 11.

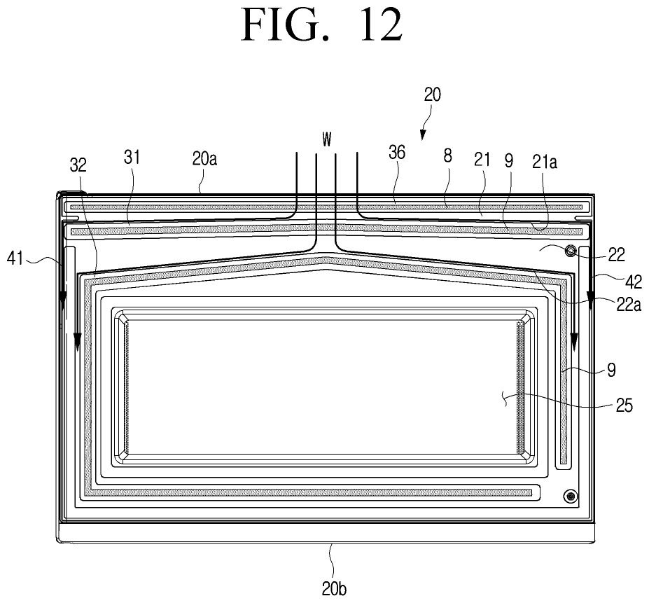

FIG. 12 is a view illustrating a flow of liquid that has penetrated into a door assembly 10 of a cooking device 1 according to an embodiment of the disclosure.

Referring to FIG. 12, the lower end 21a of the upper portion 21 of the door plate 20 is formed to be inclined toward the side end of the door plate 20.

Because a gap between the upper portion 21 of the door plate 20 and the door glass 11 is very narrow, liquid quickly spreads through the gap between the upper portion 21 of the door plate 20 and the door glass 11 by capillary action.

When the liquid flowing downward through the gap between the upper portion 21 of the door plate 20 and the door glass 11 meets the joining groove 31, the liquid does not flow down immediately but stays for a while due to surface tension.

At this time, because the lower end 21a of the upper portion 21 of the door plate 20 is formed to be inclined toward the side end of the door plate 20, the liquid flows toward the side end of the door plate 20 along the inclined lower end 21a of the upper portion 21 of the door plate 20 by gravity. In other words, the liquid does not flow into the joining groove 31, but flows toward the side end of the door plate 20 along the inclined lower end 21a of the upper portion 21 of the door plate 20.

The liquid that reaches one side end of the door plate 20 may flow downward along the discharge groove 41 or 42.

In the case shown in FIG. 12, the lower end 21a of the upper portion 21 of the door plate 20 is formed to slope downward from the center toward both side ends, so that the liquid may flow toward both side ends of the door plate 20.

Some of the liquid may flow downward through the silicone 9 provided in the joining groove 31.

The liquid that has passed through the silicone 9 in the joining groove 31 quickly spreads through the gap between the middle portion 22 of the door plate 20 and the door glass 11 by capillary action.

When the liquid flowing downward through the gap between the middle portion 22 of the door plate 20 and the door glass 11 meets the additional joining groove 32, the liquid does not flow down immediately but stays in the gap for a while due to surface tension.

At this time, because the lower end 22a of the middle portion 22 of the door plate 20 is formed to be inclined toward the side end of the door plate 20, the liquid flows toward the side end of the door plate 20 along the inclined lower end 22a of the middle portion 22 of the door plate 20 by gravity. In other words, the liquid does not flow into the additional joining groove 32, but flows toward the side end of the door plate 20 along the inclined lower end 22a of the middle portion 22 of the door plate 20.

In the case shown in FIG. 12, the lower end 22a of the middle portion 22 of the door plate 20 is formed to slope downward from the center toward both ends, so that the liquid may flow toward both side ends of the door plate 20.

The liquid that has reached both side ends of the door plate 20 may flow to the lower portion of the door plate 20 along portions of the door plate 20 between the vertical joining grooves 33 and 34 and the vertical tape grooves 37 and 38.

In addition, because the inclination angle of the lower end 22a of the middle portion 22 of the door plate 20 is greater than the inclination angle of the lower end 21a of the upper portion 21 of the door plate 20, the liquid may flow faster along the lower end 22a of the middle portion 22 of the door plate 20.

Therefore, the liquid that has penetrated into the upper end of the door assembly 10 does not flow down along the portion of the door glass 11 corresponding to the inspection window 25.

As described above, the cooking device 1 according to an embodiment of the disclosure does not allow liquid that has penetrated through the upper end of the door assembly 10 to flow to the inner surface of the door glass 11 corresponding to the inspection window 25, so that no liquid traces may exist on the inner surface of the door glass 11.

Referring again to FIG. 1, the cooking device 1 according to an embodiment of the disclosure may include the operation panel 50.

The operation panel 50 may be disposed on the front surface 5 of the main body 3. For example, the operation panel 50 may be disposed on the front surface of the main body 3 on one side of the opening. A panel section 6 on which the operation panel 50 is disposed may be provided on the front surface 5 of the main body 3 on one side of the opening.

The operation panel 50 may be configured to control the cooking device 1.

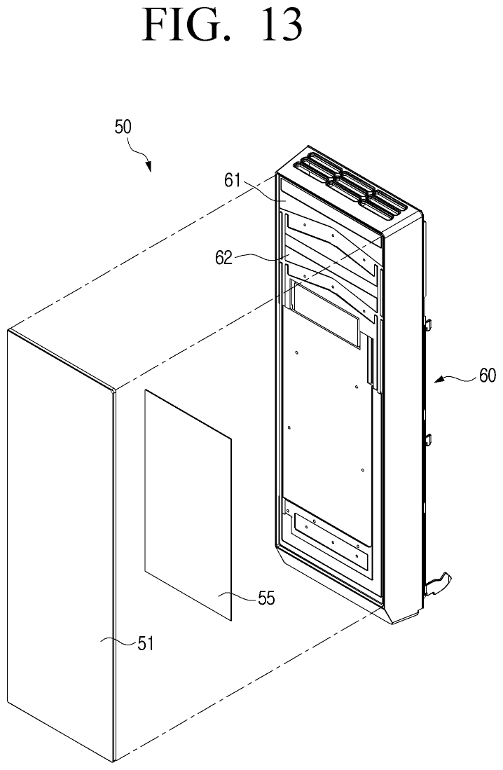

Hereinafter, the operation panel 50 of the cooking device 1 according to an embodiment of the disclosure will be described in detail with reference to FIGS. 13 to 17.

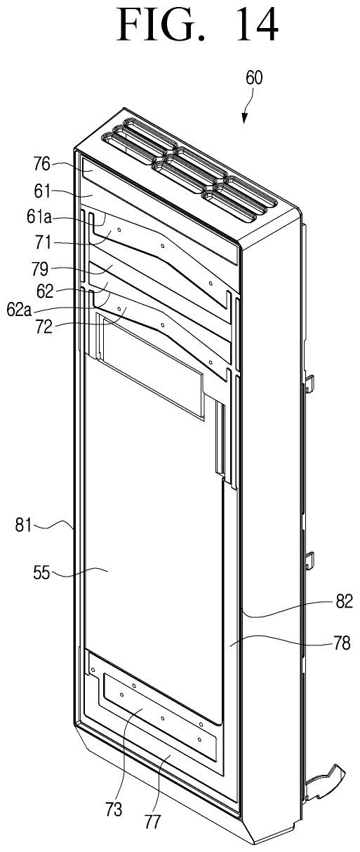

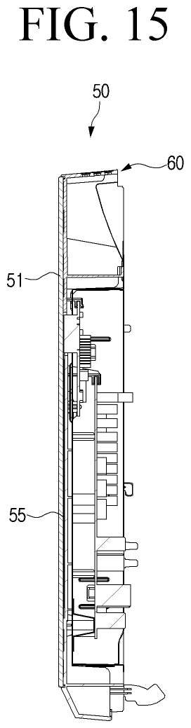

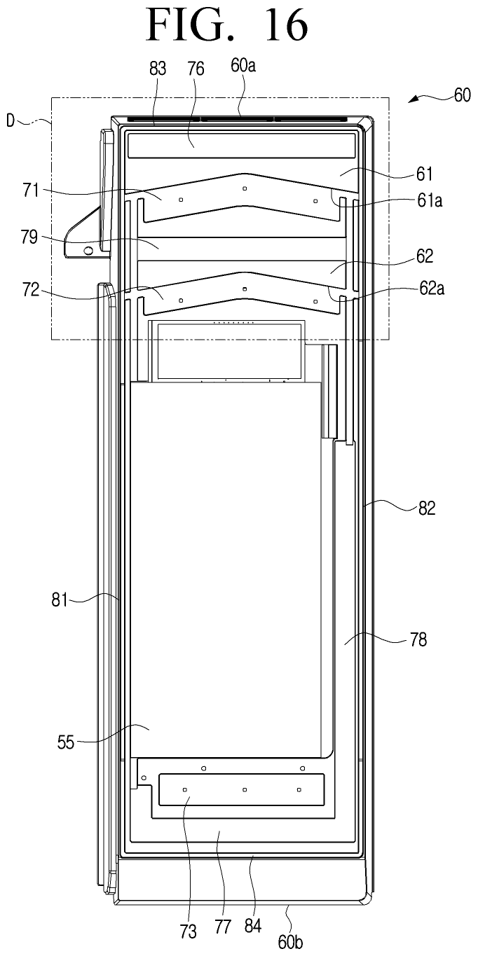

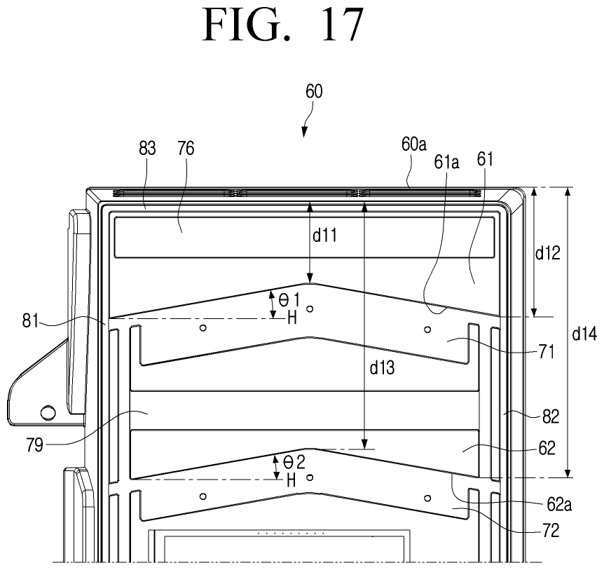

FIG. 13 is an exploded perspective view illustrating an operation panel 50 of the cooking device 1 of FIG. 1. FIG. 14 is a perspective view illustrating a panel body 60 of the operation panel 50 of FIG. 13. FIG. 15 is a cross-sectional view illustrating the operation panel 50 of the cooking device of FIG. 1 taken along a line II-II. FIG. 16 is a plan view illustrating a panel body 60 according to an embodiment of the disclosure. FIG. 17 is a partial enlarged view illustrating a part D of FIG. 16.

Referring to FIGS. 13 and 14, the operation panel 50 may include a panel body 60 and a glass panel 51. The panel body 60 and the glass panel 51 may be laminated to form the operation panel 50. For example, the operation panel 50 may be formed by attaching the glass panel 51 to the front surface of the panel body 60. The glass panel 51 may be attached to the front surface of the panel body 60 by an adhesive 8 and 9.

The panel body 60 may be disposed on the front surface 5 of the main body 3. For example, the panel body 60 may be disposed on the panel section 6 of the main body 3. The panel section 6 may be provided on one side of the opening on the front surface 5 of the main body 3.

A processor configured to control the cooking device 1 may be provided inside the panel body 60. The processor may be provide on a control board disposed inside the panel body 60.

The panel body 60 may be formed in a shape of a substantially rectangular flat plate. The panel body 60 may include a keypad 55. For example, the keypad 55 may be formed in a rectangular film shape.

The keypad 55 may be disposed on the front surface of the panel body 60. The glass panel 51 may be disposed on the front surface of the panel body 60 so as to cover the keypad 55 disposed on the front surface of the panel body 60.

The keypad 55 may be configured so that the user inputs commands. The keypad 55 may be electrically connected to the processor. For example, the keypad 55 may be formed of a membrane switch, a touch film, etc. The user may operate the keypad 55 by pressing a portion of the glass panel 51 corresponding to the keypad 55.

Nothing other than air may exist between the front surface of the panel body 60 and the glass panel 51. In other words, a narrow gap may be formed between the front surface of the panel body 60 and the glass panel 51. In addition, the front surface of the panel body 60 and the glass panel 51 may be in partial contact. Here, the front surface of the panel body 60 refers to a surface of the panel body 60 facing the glass panel 51.

The panel body 60 may include a panel joining groove 71. The panel joining groove 71 may be formed on the front surface of the panel body 60 above the keypad 55.

The panel joining groove 71 may be formed to have a defined depth on the front surface of the panel body 60. The depth of the panel joining groove 71 may be formed to be greater than the gap between the front surface of the panel body 60 and the glass panel 51. Therefore, a capillary action may not occur between the glass panel 51 and the panel joining groove 71.

The panel joining groove 71 may be provided on the upper side of the keypad 55 in the panel body 60 in the horizontal direction. The bottom of the panel joining groove 71 may be formed lower than the front surface of the panel body 60. In other words, the front surface of the panel body 60 and the bottom of the panel joining groove 71 may form a step.

A portion of the panel body 60 located on the upper side of the panel joining groove 71, that is, a portion of the panel body 60 from an upper end 60a of the panel body 60 to the panel joining groove 71, may be referred to as an upper portion 61 of the panel body 60. A lower end 61a of the upper portion 61 of the panel body 60 being in contact with the panel joining groove 71 may be formed to be inclined toward one side end of the panel body 60. An upper wall of the panel joining groove 71 may be formed to be inclined toward one side end of the panel body 60.

In other words, the lower end 61a of the upper portion 61 of the panel body 60 which is located on the upper side of the panel joining groove 71 and faces the glass panel 51 may be formed to be inclined toward the side end of the panel body 60. An inclination angle θ1 of the lower end 61a of the upper portion 61 of the panel body 60 may be defined so that liquid penetrating between the glass panel 51 and the panel body 60 flows along the lower end 61a of the upper portion 61 of the panel body 60. Here, the inclination angle θ1 of the lower end 61a of the upper portion 61 of the panel body 60 refers to an angle between the lower end 61a of the upper portion 61 of the panel body 60 and a horizontal line H. The horizontal line H refers to a straight line that passes through one end of the lower end 61a of the upper portion 61 of the panel body 60 and is parallel to the upper end 60a of the panel body 60.

When the lower end 61a of the upper portion 61 of the panel body 60 is formed to be inclined, liquid that has penetrated between the glass panel 51 and the panel body 60 may flow toward the side end of the panel body 60 along the lower end 61a of the upper portion 61 of the panel body 60. In other words, the lower end 61a of the upper portion 61 of the panel body 60 may form a liquid guide slope that guides the liquid.

As illustrated in FIG. 16, the lower end 61a of the upper portion 61 of the panel body 60 may be formed to slope downward from the center of the lower end 61a to both side ends thereof. In other words, the distance d11 from the upper end 60a of the panel body 60 to the center of the lower end 61a of the upper portion 61 of the panel body 60 may be shorter than the distance d12 from the upper end 60a of the panel body 60 to both side ends of the lower end 61a of the upper portion 61 of the panel body 60.

A lower wall of the panel joining groove 71 may be formed parallel to the upper wall thereof. As another example, the lower wall of the panel joining groove 71 may be formed parallel to the upper end 60a of the panel body 60.

The panel joining groove 71 may accommodate the adhesive 8 and 9. The adhesive 8 and 9 may be configured to join the panel body 60 and the glass panel 51. For example, double-sided tape 8 or silicone 9 may be used as the adhesive 8 and 9.

The double-sided tape 8 may be attached to the bottom of the panel joining groove 71. The upper surface of the double-sided tape 8 may be formed to protrude above the panel joining groove 71. The upper surface of the double-sided tape 8 may protrude above the front surface of the panel body 60. In other words, the thickness of the double-sided tape 8 may be greater than the depth of the panel joining groove 71. For example, the double-sided tape 8 may have a thickness that protrudes about 0.1 mm from the front surface of the panel body 60.

The glass panel 51 may be disposed on the front surface of the panel body 60 to cover the keypad 55.

The glass panel 51 may be formed in a shape and size corresponding to the panel body 60. For example, the glass panel 51 may be formed in a rectangular shape having a size corresponding to the panel body 60.

When the glass panel 51 is attached to the front surface of the panel body 60, a gap may be formed between the glass panel 51 and the front surface of the panel body 60 by the double-sided tape 8. The gap between the glass panel 51 and the front surface of the panel body 60 may be defined by the height of the double-sided tape 8 protruding from the front surface of the panel body 60. For example, when the double-sided tape 8 protrudes 0.1 mm from the front surface of the panel body 60, the gap between the glass panel 51 and the panel body 60 is approximately 0.1 mm.

Referring to FIGS. 14 and 16, the panel body 60 may include an additional panel joining groove 72. The additional panel joining groove 72 may be formed on the front surface of the panel body 60 in the horizontal direction.

The additional panel joining groove 72 may be formed below the panel joining groove 71. The additional panel joining groove 72 may be provided on the upper side of the keypad 55. In other words, the additional panel joining groove 72 may be provided between the panel joining groove 71 and the keypad 55 in the horizontal direction.

The additional panel joining groove 72 may be formed identically or similarly to the panel joining groove 71. For example, the additional panel joining groove 72 may be formed to have a defined depth on the front surface of the panel body 60. The bottom of the additional panel joining groove 72 may be formed lower than the front surface of the panel body 60. In other words, the front surface of the panel body 60 and the bottom of the additional panel joining groove 72 may form a step.

A portion of the panel body 60 located on the upper side of the additional panel joining groove 72, that is, a portion of the panel body 60 from the panel joining groove 71 to the additional panel joining groove 72, may be referred to as a middle portion 62 of the panel body 60. A lower end 62a of the middle portion 62 of the panel body 60 being in contact with the additional panel joining groove 72 may be formed to be inclined toward the side end of the panel body 60. An upper wall of the additional panel joining groove 72 may be formed to be inclined toward the side end of the panel body 60.

In other words, the lower end 62a of the middle portion 62 of the panel body 60 located on the upper side of the additional panel joining groove 72 and facing the glass panel 51 may be formed to be inclined toward the side end of the panel body 60. When the lower end 62a of the middle portion 62 of the panel body 60 is formed to be inclined, liquid that has penetrated between the glass panel 51 and the panel body 60 may flow toward the side end of the panel body 60 along the lower end 62a of the middle portion 62 of the panel body 60. That is, the lower end 62a of the middle portion 62 of the panel body 60 may form a liquid guide slope.

As illustrated in FIG. 16, the lower end 62a of the middle portion 62 of the panel body 60 may be formed to slope downward from the center of the lower end 62a to both side ends thereof. In other words, the distance d13 from the upper end 60a of the panel body 60 to the center of the lower end 62a of the middle portion 62 of the panel body 60 may be shorter than the distance d14 from the upper end 60a of the panel body 60 to both side ends of the lower end 62a of the middle portion 62 of the panel body 60.

Referring to FIG. 17, the lower end 62a of the middle portion 62 of the panel body 60 may be formed to be more inclined than the lower end 61a of the upper portion 61 of the panel body 60. In other words, the inclination angle θ2 of the lower end 62a of the middle portion 62 of the panel body 60 may be greater than the inclination angle θ1 of the lower end 61a of the upper portion 61 of the panel body 60.

A lower wall of the additional panel joining groove 72 may be formed parallel to the upper wall thereof. As another example, the lower wall of the additional panel joining groove 72 may be formed parallel to the upper end 60a of the panel body 60.

A lower panel joining groove 73 may be provided below the keypad 55. The lower panel joining groove 73 may be provided on the lower side of the keypad 55 in the front surface of the panel body 60 in the horizontal direction. The bottom of the lower panel joining groove 73 may be formed lower than the front surface of the panel body 60. In other words, the front surface of the panel body 60 and the bottom of the lower panel joining groove 73 may form a step.

A portion of the panel body 60 located on the lower side of the lower panel joining groove 73, that is, a portion of the panel body 60 from a lower end 60b of the panel body 60 to the lower panel joining groove 73, may be referred to as a lower portion 63 of the panel body 60. An upper end of the lower portion 63 of the panel body 60 being in contact with the lower panel joining groove 73 may be formed to be inclined toward one side end of the panel body 60. A lower wall of the lower panel joining groove 73 may be formed to be inclined toward one side end of the panel body 60.

In other words, the upper end of the lower portion 63 of the panel body 60 facing the glass panel 51 and located on the lower side of the lower panel joining groove 73 may be formed to be inclined toward the side end of the panel body 60.

An inclination angle of the upper end of the lower portion 63 of the panel body 60 may be defined so that liquid penetrating into the lower end of the operation panel 50, that is, between the lower end of the glass panel 51 and the lower end 60b of the panel body 60, flows along the upper end of the lower portion 63 of the panel body 60 to the side end of the panel body 60. Here, the inclination angle of the upper end of the lower portion 63 of the panel body 60 refers to an angle between the upper end of the lower portion 63 of the panel body 60 and the horizontal line H.

The additional panel joining groove 72 and the lower panel joining groove 73 may accommodate adhesives 8 and 9. The adhesives 8 and 9 may be configured to join the panel body 60 and the glass panel 51. For example, double-sided tape 8 or silicone 9 may be used as the adhesives 8 and 9.

Referring again to FIG. 16, a tape groove may be provided on the edge of the front surface of the panel body 60.

The tape groove may be formed adjacent to the upper end 60a, lower end 60b, and right end of the panel body 60. The tape groove may be formed in a straight line.

An upper tape groove 76 may be formed on the upper side of the panel joining groove 71. In other words, the upper tape groove 76 may be provided between the panel joining groove 71 and the upper end 60a of the panel body 60.

An upper wall of the upper tape groove 76 may be formed to be inclined toward the side end of the panel body 60 like the panel joining groove 71, but may be formed in a straight line to improve the joining state of the upper portion of the panel body 60 and the glass panel 51.

A lower tape groove 77 may be formed below the keypad 55. In other words, the lower tape groove 77 may be provided between the lower panel joining groove 73 and the lower end 60b of the panel body 60.

A right tape groove 78 may be formed on the right side of the keypad 55. In other words, the right tape groove 78 may be provided between the keypad 55 and the right end of the panel body 60.

The right tape groove 78 may be located below the additional panel joining groove 72. In other words, the right end of the additional panel joining groove 72 may be located above the right tape groove 78.

A tape groove 79 may be provided between the panel joining groove 71 and the additional panel joining groove 72.

The panel body 60 may include a pair of panel discharge grooves 81 and 82. The pair of panel discharge grooves 81 and 82 may be formed so that liquid that has moved to one side end of the panel body 60 along the lower end 61a of the upper portion 61 and the lower end 62a of the middle portion 62 of the panel body 60 flows downward. The pair of panel discharge grooves 81 and 82 may be formed vertically on both sides of the keypad 55.

The pair of panel discharge grooves 81 and 82 may be provided adjacent to the left and right ends of the panel body 60 on both sides of the keypad 55. A left panel discharge groove 81 may be provided between the left end of the panel body 60 and the keypad 55. A right panel discharge groove 82 may be provided between the right end of the panel body 60 and the right tape groove 78.

The panel body 60 may include an upper panel discharge groove 83 provided adjacent to the upper end 60a of the panel body 60. The upper panel discharge groove 83 may be provided between the upper tape groove 76 and the upper end 60a of the panel body 60.

The panel body 60 may include a lower panel discharge groove 84 provided adjacent to the lower end 60b of the panel body 60. The lower panel discharge groove 84 may be provided between the lower tape groove 77 and the lower end 60b of the panel body 60.

The upper panel discharge groove 83 and the lower panel discharge groove 84 may be formed to be connected to the left panel discharge groove 81 and the right panel discharge groove 82.

In the above, the case where the lower end 61a of the upper portion 61 of the panel body 60 and the lower end 62a of the middle portion 62 thereof are formed to be inclined downward from the center toward both side ends has been described, but the disclosure is not limited thereto. The inclination of the lower end 61a of the upper portion 61 of the panel body 60 and the inclination of the lower end 62a of the middle portion 62 thereof may be formed differently.

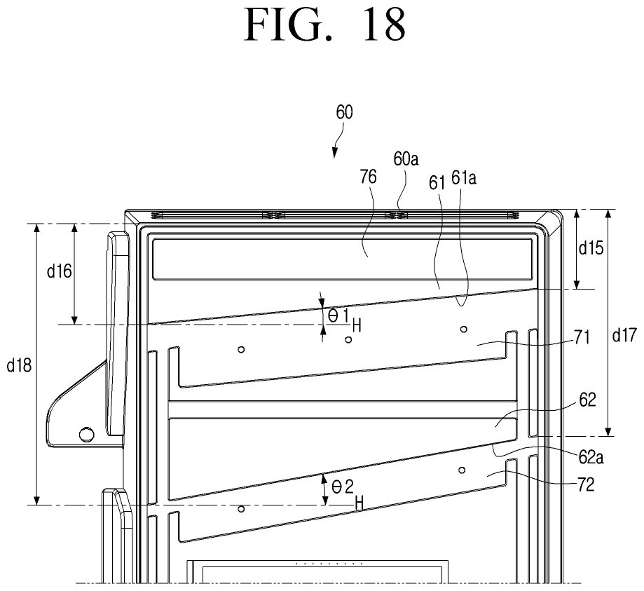

Another example of the inclinations of the lower end 61a of the upper portion 61 of the panel body 60 and the lower end 62a of the middle portion 62 thereof will be described with reference to FIG. 18.

FIG. 18 is a plan view illustrating an operation panel 50 according to an embodiment of the disclosure.

Referring to FIG. 18, the panel body 60 may be formed in a substantially rectangular flat plate shape. The panel body 60 may include a keypad 55. For example, the keypad 55 may be formed in a rectangular film shape. The keypad 55 may be electrically connected to a processor so as to control the cooking device 1.

The panel body 60 may include a panel joining groove 71. The panel joining groove 71 may be formed on the front surface of the panel body 60 above the keypad 55.

The panel joining groove 71 may be formed to have a defined depth on the front surface of the panel body 60. The panel joining groove 71 may be provided on the panel body 60 in the horizontal direction above the keypad 55. The bottom of the panel joining groove 71 may be formed lower than the front surface of the panel body 60. In other words, the front surface of the panel body 60 and the bottom of the panel joining groove 71 may form a step.

A lower end 61a of an upper portion 61 of the panel body 60 being in contact with the panel joining groove 71 may be formed to be inclined toward the side end of the panel body 60. An upper wall of the panel joining groove 71 may be formed to be inclined toward the side end of the panel body 60.

In other words, the lower end 61a of the upper portion 61 of the panel body 60 which is located on the upper side of the panel joining groove 71 and faces the glass panel 51 may be formed to be inclined toward the side end of the panel body 60.

As illustrated in FIG. 18, the lower end 61a of the upper portion 61 of the panel body 60 may be formed to slope downward from one side end of the panel body 60 toward the other side end thereof. In other words, the distance d15 from the upper end 60a of the panel body 60 to one side end of the lower end 61a of the upper portion 61 of the panel body 60 may be shorter than the distance d16 from the upper end 60a of the panel body 60 to the other side end of the lower end 61a of the upper portion 61 of the panel body 60.

For example, the lower end 61a of the upper portion 61 of the panel body 60 may be formed to slope downward from the right side to the left side. In other words, the distance d15 from the upper end 60a of the panel body 60 to the right end of the lower end 61a of the upper portion 61 of the panel body 60 may be shorter than the distance d16 from the upper end 60a of the panel body 60 to the left end of the lower end 61a of the upper portion 61 of the panel body 60.

A lower wall of the panel joining groove 71 may be formed parallel to the upper wall thereof. As another example, the lower wall of the panel joining groove 71 may be formed parallel to the upper end 60a of the panel body 60.

The panel body 60 may include an additional panel joining groove 72 formed below the panel joining groove 71. The additional panel joining groove 72 may be formed on the front surface of the panel body 60 in the horizontal direction.

The additional panel joining groove 72 may be provided on the upper side of the keypad 55. In other words, the additional panel joining groove 72 may be provided between the panel joining groove 71 and the keypad 55 in the horizontal direction.

The additional panel joining groove 72 may be formed identically or similarly to the panel joining groove 71. For example, the additional panel joining groove 72 may be formed to have a defined depth on the front surface of the panel body 60. The bottom of the additional panel joining groove 72 may be formed lower than the front surface of the panel body 60. In other words, the front surface of the panel body 60 and the bottom of the additional panel joining groove 72 may form a step.

A lower end 62a of a middle portion 62 of the panel body 60, that is, a portion of the panel body 60 from the panel joining groove 71 to the additional panel joining groove 72, may be formed to be inclined toward the side end of the panel body 60. An upper wall of the additional panel joining groove 72 may be formed to be inclined toward the side end of the panel body 60.

In other words, the lower end 62a of the middle portion 62 of the panel body 60, which is located on the upper side of the additional panel joining groove 72 and faces the glass panel 51, may be formed to be inclined toward the side end of the panel body 60.

As illustrated in FIG. 18, the lower end 62a of the middle portion 62 of the panel body 60 may be formed to slope downward from one side end of the panel body 60 to the other side end thereof. In other words, the distance d17 from the upper end 60a of the panel body 60 to one side end of the lower end 62a of the middle portion 62 of the panel body 60 may be shorter than the distance d18 from the upper end 60a of the panel body 60 to the other side end of the lower end 62a of the middle portion 62 of the panel body 60.

For example, the lower end 62a of the middle portion 62 of the panel body 60 may be formed to slope downward from the right side to the left side. In other words, the distance d17 from the upper end 60a of the panel body 60 to the right end of the lower end 62a of the middle portion 62 of the panel body 60 may be shorter than the distance d18 from the upper end 60a of the panel body 60 to the left end of the lower end 62a of the middle portion 62 of the panel body 60.

The lower end 62a of the middle portion 62 of the panel body 60 may be formed to be more inclined than the lower end 61a of the upper portion 61 of the panel body 60. In other words, the inclination angle θ2 of the lower end 62a of the middle portion 62 of the panel body 60 may be greater than the inclination angle θ1 of the lower end 61a of the upper portion 61 of the panel body 60.

A lower wall of the additional panel joining groove 72 may be formed parallel to the upper wall thereof. As another example, the lower wall of the additional panel joining groove 72 may be formed parallel to the upper end 60a of the panel body 60.

Hereinafter, a flow of liquid that has penetrated into the operation panel 50 of the cooking device 1 according to an embodiment of the disclosure will be described in detail.

When the user washes the cooking device 1 or pours water on the upper side of the cooking device 1, cleaning liquid or water may penetrate into the upper end of the operation panel 50. Hereinafter, water or cleaning liquid that may penetrate into the operation panel 50 of the cooking device 1 is referred to as liquid.

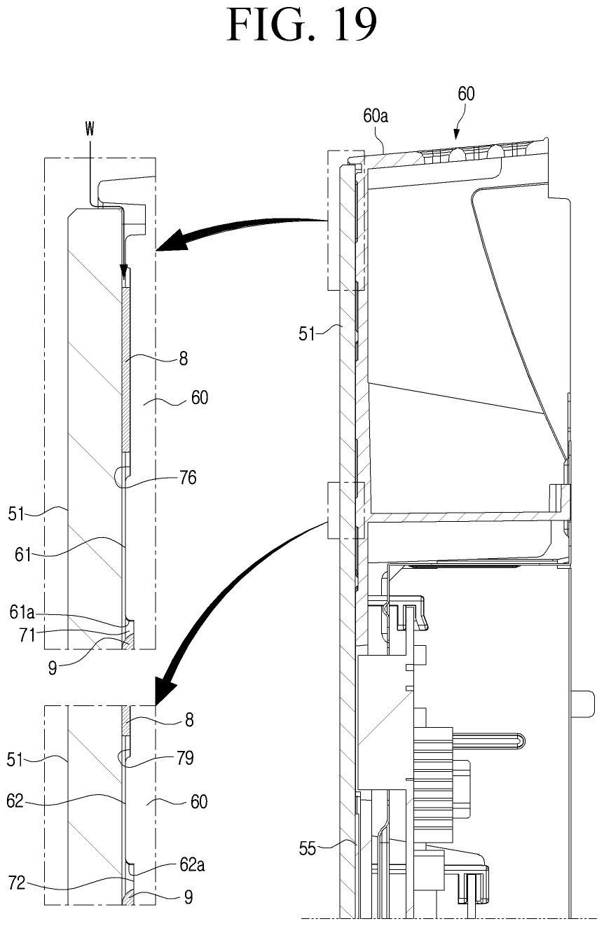

FIG. 19 is a partial cross-sectional view illustrating a state in which liquid W penetrates into an operation panel 50 of a cooking device 1 according to an embodiment of the disclosure.

Referring to FIG. 19, liquid may penetrate into the upper end of the operation panel 50, that is, between the upper end 60a of the panel body 60 and the upper end of the glass panel 51.

Because a gap between the panel body 60 and the glass panel 51 is very narrow, the liquid quickly spreads through the gap between the panel body 60 and the glass panel 51 by capillary action.

When the liquid flowing downward through the gap between the panel body 60 and the glass panel 51 meets the tape groove 76, the liquid does not flow down immediately but stays for a while. In other words, when the liquid meets the tape groove 76 whose gap is wider than the gap between the panel body 60 and the glass panel 51, the liquid does not flow down immediately but stays for a while in the gap between the panel body 60 and the glass panel 51 due to the surface tension of the liquid.

As time passes, the liquid flows down and collects on the double-sided tape 8 disposed in the tape groove. The liquid may not pass through the double-sided tape 8 directly and may be absorbed by the double-sided tape 8.

After a certain amount of time, the liquid may flow down through the double-sided tape 8.

The liquid passing through the double-sided tape 8 may penetrate into the gap between the panel body 60 and the glass panel 51.

Because the gap between the panel body 60 and the glass panel 51 is very narrow, the liquid quickly spreads through the gap between the panel body 60 and the glass panel 51 by capillary action.

When the liquid flowing downward through the gap between the panel body 60 and the glass panel 51 meets the panel joining groove 71, the liquid does not flow down immediately but stays in the gap for a while.

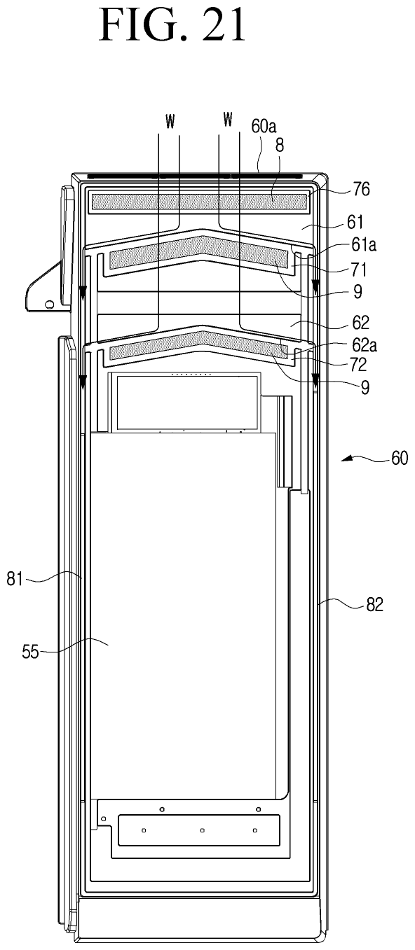

When the lower end 61a of the upper portion 61 of the panel body 60 above the panel joining groove 71 is formed horizontally, the liquid flows down directly into the panel joining groove 71 as illustrated in FIG. 21.

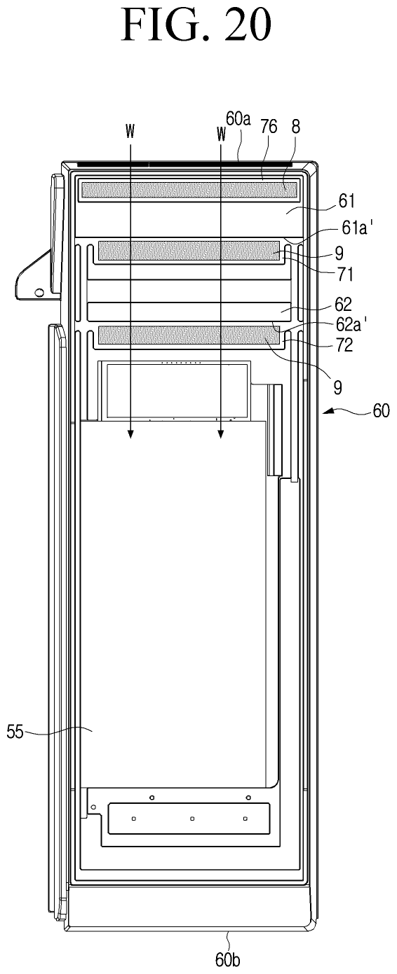

FIG. 20 is a view illustrating a flow of liquid W that has penetrated into an operation panel 50 of a cooking device according to the prior art.

Referring to FIG. 20, the lower end 61a′ of the upper portion 61 of the panel body 60 is formed horizontally parallel to the lower end of the panel body 60. In this case, the liquid passing through the gap between the upper portion 61 of the panel body 60 and the glass panel 51 flows down into the panel joining groove 71, and then flows downward through the silicone 9 provided in the panel joining groove 71.

Because the entire upper surface of the silicone 9 provided in the panel joining groove 71 is not completely in contact with the glass panel 51, the liquid may flow downward through the gap between the glass panel 51 and the silicone 9.

The liquid that has passed through the panel joining groove 71 quickly spreads through the gap between the middle portion 62 of the panel body 60 and the glass panel 51 by capillary action, and passes through the gap between the middle portion 62 of the panel body 60 and the glass panel 51.

The lower end 62a′ of the middle portion 62 of the panel body 60 is formed horizontally parallel to the lower end 60b of the panel body 60. Therefore, the liquid passing through the gap between the middle portion 62 of the panel body 60 and the glass panel 51 flows down into the additional panel joining groove 72, and then flows downward through the silicone 9 provided in the additional panel joining groove 72.

Because the entire upper surface of the silicone 9 provided in the additional panel joining groove 72 is not in complete contact with the glass panel 51, the liquid may flow downward through the gap between the glass panel 51 and the silicone 9.

The liquid passing through the additional panel joining groove 72 may penetrate into the keypad 55. Then, the liquid passing through the additional panel joining groove 72 may penetrate into the keypad 55. Then, the keypad 55 may be shorted or malfunction due to the liquid.

However, when the lower end 61a of the upper portion 61 of the panel body 60 and the lower end 62a of the middle portion 62 of the panel body 60 are formed to be inclined as in the disclosure, the liquid may be prevented from penetrating into the keypad 55.

FIG. 21 is a view illustrating a flow of liquid W that has penetrated into an operation panel 50 of a cooking device 1 according to an embodiment of the disclosure.

Referring to FIG. 21, the lower end 61a of the upper portion 61 of the panel body 60 is formed to be inclined toward the side end of the panel body 60.

Because the gap between the upper portion 61 of the panel body 60 and the glass panel 51 is very narrow, the liquid quickly spreads through the gap between the upper portion 61 of the panel body 60 and the glass panel 51 by capillary action.

When the liquid flowing downward through the gap between the upper portion 61 of the panel body 60 and the glass panel 51 meets the panel joining groove 71, the liquid does not flow down immediately but stays in the gap for a while due to surface tension.

At this time, because the lower end 61a of the upper portion 61 of the panel body 60 is formed to be inclined toward one side end of the panel body 60, the liquid flows toward the side end of the panel body 60 along the inclined lower end 61a of the upper portion 61 of the panel body 60 by gravity. In other words, the liquid does not flow into the panel joining groove 71, but flows toward the side end of the panel body 60 along the inclined lower end 61a of the upper portion 61 of the panel body 60.

The liquid that reaches one side end of the panel body 60 may flow downward the panel body 60 along the panel discharge grooves 81 and 82.

In the case shown in FIG. 21, the lower end 61a of the upper portion 61 of the panel body 60 is formed to slope downward from the center toward both ends, so that the liquid may flow toward both side ends of the panel body 60.

Some of the liquid may flow downward through the silicone 9 provided in the panel joining groove 71.

The liquid that has passed through the silicone 9 in the panel joining groove 71 quickly spreads through the gap between the middle portion 62 of the panel body 60 and the glass panel 51 by capillary action.

When the liquid flowing downward through the gap between the middle portion 62 of the panel body 60 and the glass panel 51 meets the additional panel joining groove 72, the liquid does not flow down immediately but stays in the gap for a while due to surface tension.

At this time, because the lower end 62a of the middle portion 62 of the panel body 60 is formed to be inclined toward one side end of the panel body 60, the liquid flows toward one side end of the panel body 60 along the inclined lower end 62a of the middle portion 62 of the panel body 60 by gravity. In other words, the liquid does not flow into the additional panel joining groove 72, but flows toward one side end of the panel body 60 along the inclined lower end 62a of the middle portion 62 of the panel body 60.

In the case shown in FIG. 21, the lower end 62a of the middle portion 62 of the panel body 60 is formed to slope downward from the center toward both side ends, so that the liquid may flow toward both side ends of the panel body 60.

The liquid that has reached both side ends of the panel body 60 may flow to the lower portion of the panel body 60 along the panel discharge grooves 81 and 82.

In addition, because the inclination angle of the lower end 62a of the middle portion 62 of the panel body 60 is greater than the inclination angle of the lower end 61a of the upper portion 61 of the panel body 60, the liquid may flow more quickly along the lower end 62a of the middle portion 62 of the panel body 60.

Therefore, the liquid that has penetrated into the upper end of the panel body 60 does not penetrate into the keypad 55.

As described above, the cooking device 1 according to an embodiment of the disclosure may prevent the liquid that has penetrated into the upper end of the operation panel 50 from flowing into the keypad 55, thereby preventing the keypad 55 from leaking electricity or malfunctioning.

In the above, a microwave oven has been described as an example of the cooking device 1. However, the disclosure is not limited thereto. the disclosure may be applied to other types of cooking device 1, such as an oven including a door assembly 10 configured to open and close a cooking chamber and an operation panel 50.

In the foregoing, the disclosure has been shown and described with reference to various embodiments. However, it is understood by those skilled in the art that various changes may be made in form and detail without departing from the scope of the disclosure as defined by the appended claims and equivalents thereof.

1. A cooking device comprising:
a main body, configured to form a cooking chamber, and including an opening to the cooking chamber at a front surface of the main body; and
a door assembly to open and close the opening of the main body,
wherein the door assembly comprising:
a door plate with an inspection window;
a joining groove arrangeable on an upper side of the inspection window on a front surface of the door plate along a horizontal direction;
a door glass attachable to the front surface of the door plate; and
an adhesive, arrangeable in the joining groove, and configured to connect the door plate and the door glass,
wherein a lower end of an upper portion of the door plate is located relative to an upper side of the joining groove facing the door glass, and is formed to be inclined downward toward a side end of the door plate.

2. The cooking device of claim 1, wherein
the lower end of the upper portion of the door plate is formed to slope downward from a center toward both side ends of the lower end.

3. The cooking device of claim 1, wherein
the door plate further includes an additional joining groove arrangeable between the joining groove and the inspection window, and
wherein a lower end of a middle portion of the door plate, which is located between the joining groove and the additional joining groove facing the door glass, is formed to slope downward toward the side end of the door plate.

4. The cooking device of claim 3, wherein
the lower end of the middle portion of the door plate is formed to be more inclined downward than the lower end of the upper portion of the door plate.

5. The cooking device of claim 3, wherein
the lower end of the middle portion of the door plate is formed to be inclined downward from a center toward both side ends of the lower end.

6. The cooking device of claim 1, wherein
the door plate further includes a pair of discharge grooves formed vertically on both sides of the inspection window.

7. The cooking device of claim 1, wherein
the main body further includes:
a panel section arrangeable on the front surface on one side of the opening; and
an operation panel to be disposed on the panel section.

8. The cooking device of claim 7, wherein
the operation panel comprises:
a panel body to be disposed on the panel section;
a keypad on a front surface of the panel body;
a panel joining groove arrangeable on an upper side of the keypad on the front surface of the panel body in a horizontal direction;
a glass panel disposed on the front surface of the panel body to cover the keypad; and
an adhesive, arrangeable in the panel joining groove, and configured to connect the panel body and the glass panel,
wherein a lower end of an upper portion of the panel body, which is located on an upper side of the panel joining groove and faces the glass panel, is formed to be inclined downward toward a side end of the panel body.

9. The cooking device of claim 8, wherein
the panel body further includes an additional panel joining groove arrangeable between the panel joining groove and the keypad, and
wherein a lower end of a middle portion of the panel body, which is located between the panel joining groove and the additional panel joining groove and faces the glass panel is formed to slope downward toward the side end of the panel body.

10. The cooking device of claim 9, wherein
the lower end of the middle portion of the panel body is formed to be more inclined downward than the lower end of the upper portion of the panel body.

11. The cooking device of claim 9, wherein
the lower end of the upper portion of the panel body and the lower end of the middle portion of the panel body are formed to be inclined downward from a center of the lower end toward both side ends of the lower end.

12. The cooking device of claim 8, wherein
the panel body further includes a pair of discharge grooves formed vertically on both sides of the keypad.

13. A cooking device comprising:
a main body; and
an operation panel on a front surface of the main body,
wherein the operation panel comprises:
a panel body disposed on the front surface of the main body;
a keypad on a front surface of the panel body;
a panel joining groove arrangeable on an upper side of the keypad on the front surface of the panel body in a horizontal direction;
a glass panel to be disposed on the front surface of the panel body to cover the keypad; and
an adhesive, arrangeable in the panel joining groove, and configured to connect the panel body and the glass panel,
wherein a lower end of an upper portion of the panel body is located relative to an upper side of the panel joining groove facing the glass panel, and is formed to be inclined downward toward a side end of the panel body.

14. The cooking device of claim 13, wherein
the panel body further includes an additional panel joining groove arrangeable between the panel joining groove and the keypad, and
wherein a lower end of a middle portion of the panel body, which is located between the panel joining groove and the additional panel joining groove facing the glass panel, is formed to slope downward toward the side end of the panel body.

15. The cooking device of claim 14, wherein
the lower end of the middle portion of the panel body is formed to be more inclined downward than the lower end of the upper portion of the panel body.
